(19) United States
(12) Patent Application Publication
(10) Pub. No.: US 2026/0212651 A1
(43) Pub. Date: Jul. 23, 2026

(54) MACHINE LEARNING-BASED LESION IDENTIFICATION USING SYNTHETIC TRAINING DATA

(71) Applicant: The Regents of the University of Colorado, a body corporate, Denver, CO (US)

(72) Inventors: Bennett Bing CHIN, Denver, CO (US); Xinyl Yang, Denver, CO (US)

(21) Appl. No.: 18/717,166

(22) PCT Filed: Dec. 6, 2022
(86) PCT No.: PCT/US22/81003

§ 371 Date: Jun. 6, 2024

Related U.S. Application Data
(60) Provisional application No. 63/264,969, filed on Dec. 6, 2021.

(51) Int. Cl. G06V 10/774; G06T 7/00; G06V 10/70

(52) U.S. Cl. CPC G06V 10/774; G06T 7/0012; G06V 10/87; G06T 2207/10088; G06T 2207/10104; G06T 2207/20081; G06T 2207/30096; G06V 2201/03

(57) ABSTRACT

Aspects of the present disclosure relate to machine learning-based lesion identification using synthetic training data. In examples, one or more computer-generated features may be generated within patient imaging data for a set of patients. For example, a computer-generated feature may be generated according to a set of characteristics, such as a shape, size, and location of the feature, among other feature characteristics. The characteristics may be used to annotate the imaging data comprising the computer-generated feature, thereby forming a synthetic training dataset. Accordingly, a machine learning model may be trained using the synthetic training dataset, thereby enabling the machine learning model to classify actual features in patient imaging data. Thus, aspects described herein enable the generation and subsequent application of synthetic training data with reduced involvement by highly skilled radiologists and/or other individuals.

### CROSS-REFERENCE TO RELATED APPLICATION

This application claims priority to U.S. Provisional Application No. 63/264,969, titled “MACHINE LEARNING-BASED LESION IDENTIFICATION USING SYNTHETIC TRAINING DATA,” filed on Dec. 6, 2021, the entire disclosure of which is hereby incorporated by reference in its entirety.

### BACKGROUND

Image interpretation by radiologists typically involves extensive training and experience. Accordingly, acquiring an adequate training dataset (e.g., comprising annotated training data) with which to train a machine learning model may be time consuming and expensive. Such difficulties may be further compounded in instances where multiple machine learning models are desirable, for example such that each machine learning model may be trained using a different training dataset to ultimately perform classification in a different context. These and other challenges may negatively affect the availability of adequate datasets or even the existence of trained machine learning models with which to perform such analyses.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to machine learning-based lesion identification using synthetic training data. In examples, one or more computer-generated features may be generated within patient imaging data for a set of patients. For example, a computer-generated feature may be generated according to a set of characteristics, such as a shape, size, and location of the feature, among other feature characteristics. The characteristics may be used to annotate the imaging data comprising the computer-generated feature, thereby forming a synthetic training dataset. Accordingly, a machine learning model may be trained using the synthetic training dataset, thereby enabling the machine learning model to classify actual features in patient imaging data. Thus, aspects described herein enable the generation and subsequent application of synthetic training data with reduced involvement by highly skilled radiologists and/or other individuals.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in accordance with aspects described herein.

FIG. 2 illustrates an overview of an example method for performing machine learning-based lesion identification using synthetic training data according to aspects described herein.

FIG. 3A illustrates an overview of an example method for generating synthetic training data according to aspects described herein.

FIG. 3B illustrates an overview of example processing steps associated with generating synthetic training data according to aspects described herein.

FIG. 4 illustrates an overview of an example method for processing patient image data using a machine learning model trained using synthetic training data according to aspects described herein.

FIG. 5 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Image interpretation by radiologists typically involves extensive training and experience. For example, a radiologist may be skilled in the visual appearance of structures, normal physiologic information, and clinical pretest probability of disease. However, the shortage of such skilled labor has resulted in a very high cost for such services. As a result, obtaining a training dataset comprising lesions or other features annotated by one or more radiologists (e.g., for training a machine learning model) may be time consuming and expensive. Further, obtaining a large workforce of radiologists with sufficient imaging expertise in different modalities with which to create such a training dataset may not be feasible in today's work environment. These and other barriers may exist to acquiring a training dataset with which to train a machine learning model.

Another obstacle in developing machine learning algorithms may be the lack of generalizability of an algorithm and/or dataset. For example, an algorithm may be useful in a first context having a first set of characteristics (e.g., in a particular application or a specific use case), though the priorities or primary objectives for which the algorithm is trained may not be suitable for a second context having a second set of characteristics. For instance, the first set of characteristics may be associated with a specific instrument, a specific imaging acquisition and processing protocol, a specific disease process, and/or a specific imaging modality, such that the algorithm may have reduced or unusable performance when applied in a different context or environment (e.g., with different instruments, protocols, disease states, and/or even different molecular imaging radiotracers, among other characteristics). Newer, advanced instrumentation may provide different image spatial resolution, different image noise properties, and/or differences in quantitative accuracy. As another example, instrument imaging properties may be vendor specific due to proprietary software. Thus, a large and potentially prohibitive amount of resources may be associated with generating another training dataset that accounts for such contextual differences with which to develop or train a different machine learning model or algorithm.

Accordingly, aspects of the present disclosure relate to machine learning-based lesion identification using synthetic training data. In examples, patient imaging data is acquired from an imaging device, such as a positron emission tomography (PET) imaging device. For example, the patient imaging data may be for normal patients (e.g., patients not exhibiting an imaging feature for which a machine learning model is to be trained) having a wide range of physical characteristics. As an example, patient imaging data for healthy adult female patients ranging in age 18-85, with body mass index of 20-40, could be acquired to simulate an adult female population being studied for breast cancer. As another example, patient imaging data for healthy male patients aged 35-85 with body mass index of 20-40 could be acquired to simulate an adult male population being studied for gastroenteropancreatic neuroendocrine tumors (GEP-NETs).

The patient imaging data may be processed to generate synthetic training data, where one or more computer-generated features are added to patient imaging data for each normal patient. For example, one or more computer-generated lesions could be incorporated into normal patient imaging data. As a result of the computer-generated nature of such features, the synthetic training data may further comprise annotations associated with the computer-generated features, including, but not limited to, feature boundaries and other feature geometry.

Thus, as compared to techniques in which patient imaging data that includes actual or physical features is obtained and manually annotated by skilled radiologists, aspects of the present disclosure enable potentially more efficient (e.g., at a lower cost and/or reduced delay) generation of well-annotated synthetic training data. Further, the patient imaging data comprising actual features is potentially context-dependent, such that it may not be usable in other contexts. For example, a machine learning model trained using such patient imaging data may not be usable to classify imaging data acquired by a different imaging device, having different features, or associated with a different population of patients, among other examples.

By contrast, synthetic training data according to aspects described herein may be generated and used to train machine learning models for use in any of a variety of contexts. For example, computer-generated lesions or other features may be generated according to a set of synthetic characteristics, such that the synthetic training data and resulting machine learning model is usable to perform classification in contexts having similar characteristics to the synthetic characteristics. Accordingly, multiple synthetic training datasets may be generated for any of a variety of contexts using the same or similar underlying patient imaging data as-needed, rather than having to acquire (and manually annotate) new and different actual patient imaging data for such contexts.

Example techniques for generating synthetic training data are described herein, for example accounting for the physics of the radiotracer imaging, the instrumentation, the specific body habitus, and the technique or algorithm used to generate pre-reconstruction raw data (which may be referred to herein as a “sinogram”). However, it will be appreciated that the aspects described herein are not so limited and that any of a variety of other techniques may be used, for example having additional, fewer, or alternative steps.

In examples, photons generated by an imaging device may undergo scatter, attenuation, and other physical effects (e.g., within the body of a patient), which may make localization of the radiotracer associated with a feature imprecise. Additionally, the instrumentation may not be able to precisely localize the origin of the radiotracer activity due to physical limitations of the imaging device, including, but not limited to, limitations camera spatial resolution or timing resolution for time of flight (TOF). Thus, a computer-generated feature may not be simply added to patient imaging data because it may be beneficial to incorporate the physical effects into the imaging data at an earlier stage (e.g., in the pre-reconstructed image space). Rather, synthetic feature generation may instead be incorporated into the “sinogram space,” so that the specific physical effects of the imagine device and/or the effects of the reconstruction algorithm, among other effects, can be incorporated into the resulting synthetic imaging data.

As used herein, a “modulation transfer function” may be used to account for such effects, which may be radiotracer dependent, imaging device dependent, software correction dependent, and/or institutional operator dependent (different acquisition and processing techniques), among other examples. As a result of inserting a computer-generated feature into imaging data for a given patient according to the modulation transfer function, the synthetic imaging data may comprise a physically realistic representation of the synthetic feature for a specific patient. Thus, as compared to inserting a synthetic feature into the final patient imaging data, inserting synthetic features into the sonogram space instead (e.g., according to a modulation transfer function) accounts for imaging variability that may result from the above-described effects, among others.

Further, because any of a variety of synthetic feature characteristics can be controlled (known activities, sizes, shapes, and locations) for the computer-generated features, a machine learning model can be rapidly, accurately, and reproducibly trained for any of a variety of contexts. Further, due to the computer-generated nature of the synthetic features, the boundaries of the features within the synthetic imaging data are predetermined or otherwise known, such that the resulting training dataset may further be annotated accordingly. As noted above, such aspects may eliminate or otherwise reduce manual involvement (e.g., from a radiologist) for acquiring training data with which to train machine learning models.

A machine learning model trained using synthetic training data according to aspects described herein may then be used to process new patient imaging data, thereby enabling classification of one or more features therein, if present, for which the machine learning model was trained to identify. Such new patient imaging data may be acquired in a diagnostic context (e.g., to identify one or more features potentially therein) or in a clinical trial context (e.g., to identify features and quantify changes associated therewith, as may be the result of treatment), among other examples.

For example, an indication of a resulting classification may be presented to a user of a client computing device for review and/or interpretation. The indication may comprise emphasizing or otherwise drawing attention to one or more regions of the patient imaging data. In some instances, the indication may further comprise a display of a level of certainty associated with the classification and/or an the classification itself (e.g., normal, abnormal, and/or a type of feature that was identified by the machine learning model).

In some instances, the machine learning model that is applied to the new patient imaging data may be selected from a set of available machine learning models, where each machine learning model has been trained for one or more contexts (e.g., having an associated set of characteristics). For example, the machine learning model may be selected automatically, manually, or a combination thereof, according to patient characteristics, known or suspected characteristics associated with a feature, and/or characteristics of the imaging device, among other examples.

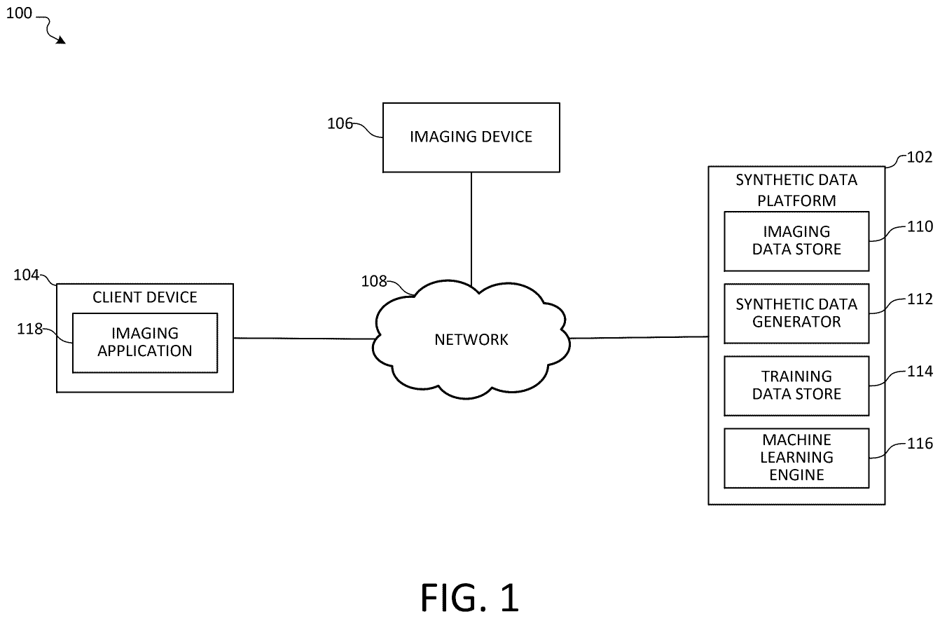

FIG. 1 illustrates an overview of an example system 100 in accordance with aspects described herein. As illustrated, system 100 comprises synthetic data platform 102, client device 104, imaging device 106, and network 108. In examples, synthetic data platform 102, client device 104, and imaging device 106 communicate via network 108. For example, network 108 may comprise a local area network, a wireless network, or the Internet, or any combination thereof, among other examples. In other examples, a computing device may more directly communicate with imaging device 106, for example using a wired or wireless data connection. In such instances, the computing device may communicate imaging data to synthetic data platform 102 (e.g., via network 108) or, as another example, synthetic data platform 102 or client device 104 may itself be the computing device connected to imaging device 106.

It will be appreciated that while system 100 is illustrated as comprising one synthetic data platform 102, one client device 104, and one imaging device 106, any number of such elements may be used in other examples. For example, imaging data from multiple imaging devices may be processed by a single synthetic data platform or, as another example, different imaging devices may each have an associated synthetic data platform. Further, the functionality described herein may be distributed among or otherwise implemented on any number of different computing devices in any of a variety of other configurations in other examples. For example, client device 104 may implement aspects associated with machine learning engine 116 discussed below, such that newly acquired patient imaging data may be processed by client device 104 in addition or as an alternative to processing by synthetic data platform 102.

Imaging device 106 may be any of a variety imaging devices, including, but not limited to, a PET imaging device or a magnetic resonance imaging (MRI) device. It will be appreciated that, while imaging device 106 is illustrated as a single imaging device, imaging device 106 need not be limited to a single imaging device and/or a single imaging technology. For example, imaging device 106 may generate patient imaging data according to both PET and MRI imaging technologies, among other examples.

Synthetic data platform 102 is illustrated as comprising imaging data store 110, synthetic data generator 112, training data store 114, and machine learning engine 116. In examples, patient imaging data is acquired from imaging device 106 and stored in imaging data store 110. Imaging data stored in imaging data store 110 may be stored in association with metadata associated with the patient imaging data, including, but not limited to, patient characteristics (e.g., gender, age, and/or body mass index) and imaging device characteristics (e.g., manufacturer, model, and/or an indication as to a reconstruction algorithm associated therewith).

Synthetic data generator 112 may generate synthetic patient imaging data from patient imaging data stored by imaging data store 110. For example, synthetic data generator 112 may process imaging data of a patient according to aspects described herein to insert one or more computer-generated features. A feature may be generated according to a set of synthetic characteristics, at least some of which may be characteristics of the imaging data (e.g., as may be stored by metadata associated therewith). For instance, synthetic data generator 112 may utilize a modulation transfer function that accounts for a manufacturer and/or model of imaging device 106 or other physical effects associated therewith. As another example, synthetic data generator 112 may generate a feature according to one or more patient characteristics. In some examples, the synthetic characteristics further comprises a set of feature characteristics, such as a feature shape, size, or location, among other examples.

Synthetic imaging data generated by synthetic data generator 112 may be stored as synthetic training data in training data store 114. In examples, the synthetic imaging data is stored as annotated synthetic training data, where synthetic imaging data for each patient is stored in association with one or more annotations, including, but not limited to, one or more feature boundary, a type of feature, and/or a feature activity level.

Accordingly, machine learning engine 116 may train a machine learning model according to synthetic training data stored in training data store 114. In examples, machine learning engine 116 may provide an indication to synthetic data generator 112 to generate synthetic training data according to a set of synthetic characteristics, such that a machine learning model may be trained according to the resulting synthetic training dataset. In some examples, machine learning engine 116 maintains a set of models, where each model of the set of models is trained for one or more contexts associated with the set of synthetic characteristics. Thus, models of synthetic data platform 102 may be applicable to any of a variety of contexts. As another example, as new contexts emerge, synthetic data generator 112 may generate associated synthetic training data accordingly. For instance, the synthetic training data may be generated based on pre-existing patient imaging data, as may be stored by imaging data store 110.

Client device 104 is illustrated as comprising imaging application 118. In examples, imaging application 118 obtains patient imaging data associated with imaging device 106 (e.g., from imaging device 106 and/or from imaging data store 110). Imaging application 118 may present at least a part of the imaging data to a user of client device 104. In some examples, the imaging data may be processed by a machine learning model of synthetic data platform 102. For example, at least a part of the imaging data may be provided to synthetic data platform 102 for processing by machine learning engine 116, such that a model processing result may be received in response. As another example, imaging application 118 may obtain a trained machine learning model from synthetic data platform 102, such that the machine learning model may be used by imaging application 118 to evaluate the patient imaging data accordingly.

As noted above, multiple machine learning models may be available with which to process the patient imaging data. In some instances, a machine learning model may be automatically selected from the set of available machine learning models, for example based on characteristics associated with the patient imaging data. In other examples, a user selection of a specific machine learning model may be received. Thus, any of a variety of techniques may be used to select a machine learning model with which to process the patient imaging data accordingly.

As a result of processing the patient imaging data using the machine learning model, imaging application 118 may provide an indication accordingly. For example, imaging application 118 may provide an indication that no feature was identified. As another example, imaging application 118 may emphasize or otherwise indicate one or more identified features within the patient imaging data. In some instances, a certainty level or classification result may be presented.

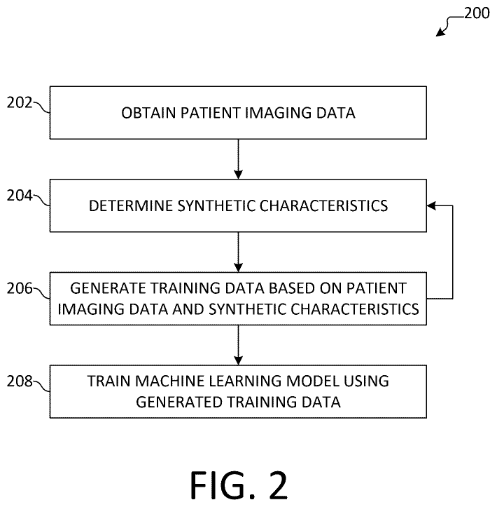

FIG. 2 illustrates an overview of an example method 200 for performing machine learning-based lesion identification using synthetic training data according to aspects described herein. In examples, aspects of method 200 are performed by a synthetic data platform, such as synthetic data platform 102 discussed above with respect to FIG. 1.

Method 200 begins at operation 202, where patient imaging data is obtained. For example, patient imaging data may be obtained from or otherwise associated with an imaging device, such as imaging device 106 in FIG. 1. As another example, at least a part of the patient imaging data may be obtained from an imaging data store, such as imaging data store 110. The obtained patient imaging data have associated metadata, including, but not limited to, imaging device characteristics and/or patient characteristics.

Flow progresses to operation 204, where a set of synthetic characteristics is determined. For example, at least a part of the synthetic characteristics may be based on metadata associated with the imaging data that was obtained at operation 202. For example, one or more synthetic characteristics may indicate a manufacturer and/or model associated with the imaging device with which the imaging data was acquired. As another example, one or more synthetic characteristics may indicate gender, age, and/or body mass index of the patient with which the imaging data is associated. Operation 204 may further comprise determining one or more feature characteristics of the set of synthetic characteristics. For example, operation 204 may randomly determine a feature size, shape, or location, among other characteristics. In other examples, such feature characteristics may be programmatically or deterministically determined, for example according to a distribution associated with historically observed features or a model indicative of expected, possible, or likely feature characteristics. Thus, it will be appreciated that any of a variety of techniques may be used to determine a set of synthetic characteristics (e.g., associated with an imaging device, patient, and/or synthetic feature).

Moving to operation 206, synthetic training data may be generated based on the patient imaging data that was obtained at operation 202 and the set of synthetic characteristics that was determined at operation 204. As discussed above, the synthetic training data may be generated by projecting a computer-generated feature into a sinogram for the patient imaging data, which may then be processed according to a modulation transfer function (e.g., based on the synthetic characteristics). Thus, the resulting synthetic imaging data may include the computer-generated feature that is adapted to account for physical and/or computational effects, among other examples, of the imaging process. The synthetic imaging data may be stored as part of a synthetic training dataset in a training data store, such as training data store 114 discussed above with respect to FIG. 1. For example, the synthetic training data may be annotated based at least in part on one or more synthetic characteristics associated therewith.

An arrow is illustrated from operation 206 to operation 204 to indicate that aspects of method 200 may be iterative. For example, at least some of the synthetic characteristics determined at operation 204 may vary from patient to patient or between instances of patient imaging data, thereby introducing variability into the synthetic training data that is generated at operation 206. For example, feature characteristics may be varied to improve the quality of the synthetic training dataset and the performance of the resulting machine learning model.

Eventually, flow progresses to operation 208, where a machine learning model is trained according to the synthetic training dataset. For example, the machine learning model may be trained based on annotations associated with synthetic imaging data, such that model performance may be evaluated based on known characteristics of one or more features therein. In examples, the trained machine learning model may be stored and/or provided to another computing device for subsequent use. Method 200 terminates at operation 208.

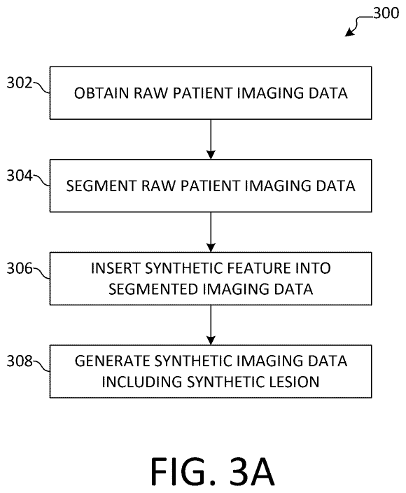

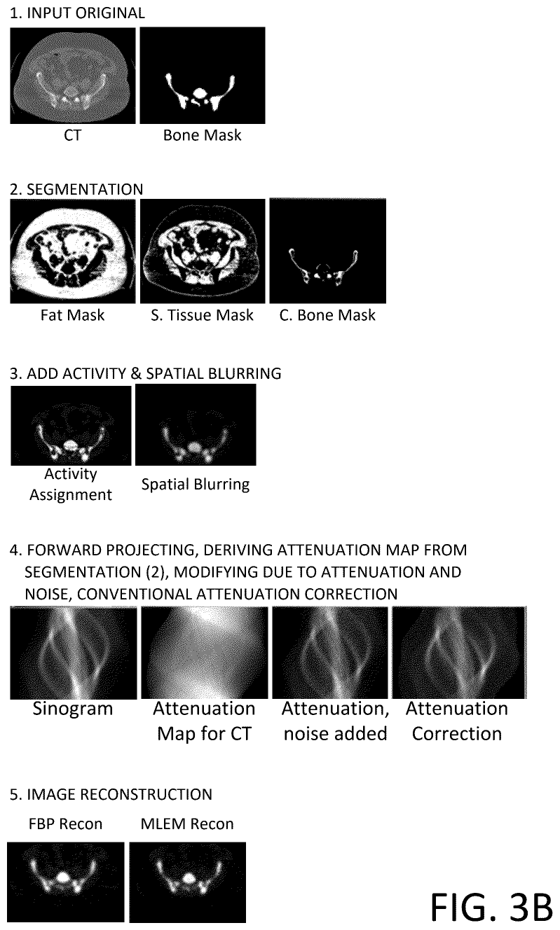

FIG. 3A illustrates an overview of an example method 300 for generating synthetic training data according to aspects described herein. In examples, aspects of method 300 are performed by a synthetic data generator, such as synthetic data generator 112 of synthetic data platform 102 discussed above with respect to FIG. 1. Aspects of FIG. 3A are further described with reference to FIG. 3B, which illustrates an overview of example processing steps associated with generating synthetic training data according to aspects described herein.

Method 300 begins at operation 302, where the original patient imaging data is obtained. For example, the original patient imaging data may be obtained from an imaging device (e.g., imaging device 106) and/or from an imaging data store (e.g., imaging data store 110), among other examples. An example of obtained patient imaging data is illustrated in the aspects associated with reference numeral 1 of FIG. 3B.

Flow progresses to operation 304, where the original patient imaging data is segmented. For example, the imaging data may be segmented to define the boundaries of bones, tissue, and fat, among other features therein. Example aspects of such segmentation are illustrated in FIG. 3B in association with reference numeral 2. In some instances, segmentation may be performed based on data from various types of imaging technology, for example based on a combination of PET and MRI data.

Moving to operation 306, one or more synthetic features are inserted into the segmented image data. For example, a feature may affect various segments differently, such that one or more segments generated at operation 304 may be adapted accordingly at operation 306. In examples, operation 306 further comprises simulating one or more physical effects associated with the imaging device (e.g., as may be specified by a set of synthetic characteristics). For example, reference numerals 3 and 4 of FIG. 3B illustrate the performance of assigning activity, spatial blurring, forward projecting, deriving attenuation map from segmented CT image (e.g., FIG. 2 above), and introducing attenuation and noise into the sinogram. After combining with raw patient PET data, the attenuation correction algorithm can be applied, which may include the synthetic feature. Thus, the simulated feature may be “forward projected” (representing raw data or “sinogram” data, for example according to a modulation transfer function) by mathematically transforming object data into its raw data form and incorporating various effects into the raw data such as image noise, thereby simulating the signal associated with the computer-generated feature that would have been obtained by the imaging device.

At operation 308, the resulting synthetic imaging data is generated, as illustrated in association with reference numeral 5 in FIG. 3B. For example, filtered back projection (FBP) or iterative reconstruction (MLEM Recon) may be performed as part of operation 308 to generate the final reconstructed imaging data that may be stored as synthetic training data accordingly. Method 300 terminates at operation 308. It will be appreciated that FIGS. 3A and 3B are provided as example aspects for generating synthetic training data from patient imaging data and synthetic characteristics and, in other examples, any of a variety of other techniques may be used.

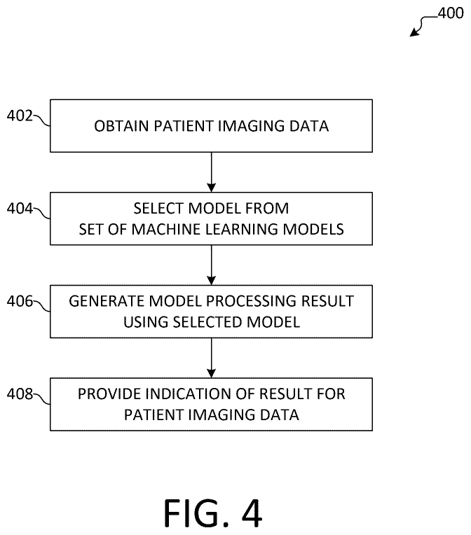

FIG. 4 illustrates an overview of an example method 400 for processing patient image data using a machine learning model trained using synthetic training data according to aspects described herein. In examples, aspects of method 400 may be performed by a machine learning engine (e.g., machine learning engine 116 in FIG. 1) and/or an imaging application (e.g., imaging application 118), among other examples.

Method 400 begins at operation 402, where patient imaging data is obtained. For example, patient imaging data may be obtained from or otherwise associated with an imaging device, such as imaging device 106 in FIG. 1. As another example, at least a part of the patient imaging data may be obtained from an imaging data store, such as imaging data store 110. The obtained patient imaging data may be associated with metadata, including, but not limited to, imaging device characteristics and/or patient characteristics.

At operation 404, a machine learning model is selected from a set of machine learning models. For instance, the machine learning model may be selected according to associated metadata. As an example, the set of machine learning models may comprise one or more models associated with a manufacturer, an imaging device model, a specific feature the model is trained to identify, and/or a specific group of patients (e.g., according to gender, age, and/or body mass index).

Flow progresses to operation 406, where a model processing result is generated using the model that was selected at operation 404. For example, the model processing result may comprise one or more regions of the obtained patient imaging data that were identify as potential regions in which a feature is present. In some instances, the model processing result comprises a confidence score and/or an indication as to a type of feature that was identified. While example model processing results are described, it will be appreciated that additional, fewer, or alternative processing results may be generated in other examples.

At operation 408, an indication of the processing result is provided. For example, the indication may be provided to a client device (e.g., by a synthetic data platform), such that an imaging application thereon may present the indication of the model processing result to the user accordingly. In instances where aspects of method 400 are performed by such a client device, operation 408 may comprise generating a display based on the model processing result, for example emphasizing or otherwise indicating one or more identified regions. In some instances, a confidence score and/or feature type may be presented in association with an identified region. Method 400 terminates at operation 408.

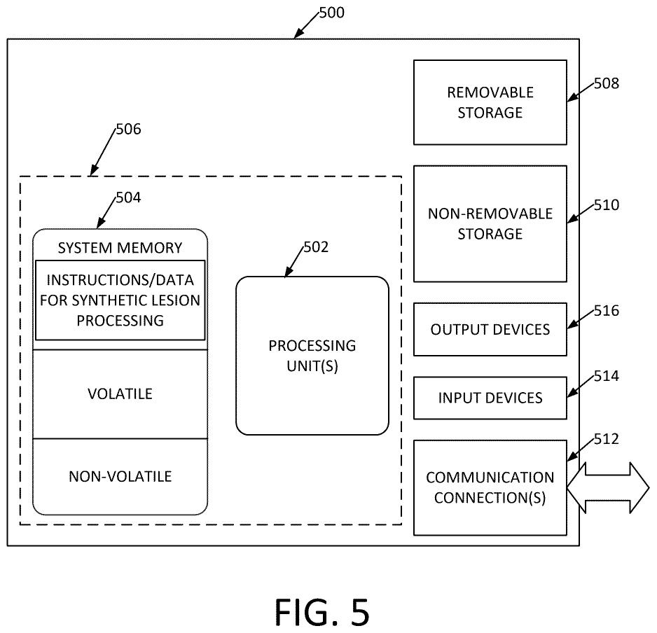

FIG. 5 illustrates an example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 may include at least some form of computer readable media. The computer readable media may be any available media that can be accessed by processing unit 502 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein such as the methods illustrated in FIGS. 2, 3A-3B, or 4, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: obtaining patient imaging data; generating, based on the patient imaging data, a synthetic training dataset associated with a feature type; training a machine learning model using the synthetic training dataset; obtaining new patient imaging data; processing the new patient imaging data according to the trained machine learning model to generate a model processing result associated with the feature type; and providing an indication of the model processing result associated with the feature type. In an example, the patient imaging data is associated with a set of imaging device characteristics; and the synthetic training dataset is generated based at least in part on the set of imaging device characteristics. In an other example, the synthetic training dataset is a first synthetic training dataset; the feature type is a first feature type; and the set of operations further comprises: generating, based on the patient imaging data, a second synthetic training dataset associated with a second feature type different than the first feature type. In a further example, generating the synthetic training dataset comprises: identifying an instance of patient imaging data from the obtained patient imaging data; and for the identified instance of patient imaging data: generating a set of feature characteristics for the feature type; and inserting a computer-generated feature of the feature type into the instance of patient imaging data to generate an instance of synthetic patient imaging data. In yet another example, generating the synthetic training dataset further comprises: annotating the instance of synthetic patient imaging according to a location associated with the computer-generated feature. In a further still example, generating the set of feature characteristics comprises at least one of: determining a shape of the computer-generated feature; determining a location of the computer-generated feature; or determining a size of the computer-generated feature. In another example, processing the new patient imaging data according to the trained machine learning model comprises: selecting the trained machine learning model from a set of machine learning models based on a set of characteristics associated with the new patient imaging data.

In another aspect, the technology relates to a method for processing patient imaging data according to a machine learning model trained using a synthetic training dataset. The method comprises: providing, to a synthetic data platform, patient imaging data; receiving, from the synthetic data platform, an indication of model processing result associated with the machine learning model; and generating a display of at least a part of the patient imaging data in association with the model processing result. In an example, the patient imaging data is obtained from an image capture device prior to providing the patient imaging data to the synthetic data platform. In another example, the patient imaging data is provided to the synthetic data platform in association with an imaging device characteristic of the imaging device; and the machine learning model is associated with the imaging device characteristic. In a further example, the synthetic data platform trains the machine learning model in response to receiving the imaging device characteristic of the imaging device. In yet another example, the display comprises at least one of: a region associated with a feature indicated by the model processing result; or a confidence associated with the model processing result. In a further still example, the confidence is displayed in association with the region associated with the indicated feature.

In a further aspect, the technology relates to a method for processing patient imaging data according to a machine learning model trained using a synthetic training dataset. The method comprises: obtaining patient imaging data; selecting a machine learning model from a set of machine learning models based on a set of characteristics associated with the patient imaging data; processing the patient imaging data according to the selected machine learning model to generate a model processing result identifying a feature of the patient imaging data; and providing an indication of the model processing result. In an example, the model is selected based on an imaging device characteristic of the set of characteristics. In another example, the model is selected based on an association between the machine learning model and a feature type of the identified feature. In a further example, the patient imaging data is obtained from a patient imaging device and the indication of the model processing result is provided to a client device. In yet another example, selecting the machine learning model from the set of machine learning models comprises: determining a machine learning model associated with a characteristic of the set of characteristics is not available in the set of machine learning models; generating a synthetic training dataset associated with the characteristic; training a machine learning model using the synthetic training dataset; and using the trained machine learning model as the selected machine learning model. In a further still example, the model processing result includes at least one of: a region associated with the identified feature; or a confidence associated with the identified feature. In another example, the patient imaging data is a first instance of patient imaging data; the set of characteristics is a first set of imaging device characteristics; and the method further comprises: receiving a second instance of patient imaging data associated with a second set of imaging device characteristics; determining a machine learning model corresponding to the second set of imaging device characteristics is not available; and based on determining the machine learning model is not available: generating a synthetic training dataset for the second set of imaging device characteristics; training a machine learning model using the synthetic training dataset; and processing the second instance of patient imaging data according to the trained machine learning model to generate a model processing result.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining patient imaging data;
generating, based on the patient imaging data, a synthetic training dataset associated with a feature type;
training a machine learning model using the synthetic training dataset;
obtaining new patient imaging data;
processing the new patient imaging data according to the trained machine learning model to generate a model processing result associated with the feature type; and
providing an indication of the model processing result associated with the feature type.

2. The system of claim 1, wherein:
the patient imaging data is associated with a set of imaging device characteristics; and
the synthetic training dataset is generated based at least in part on the set of imaging device characteristics.

3. The system of claim 1, wherein:
the synthetic training dataset is a first synthetic training dataset;
the feature type is a first feature type; and
the set of operations further comprises:
generating, based on the patient imaging data, a second synthetic training dataset associated with a second feature type different than the first feature type.

4. The system of claim 1, wherein generating the synthetic training dataset comprises:
identifying an instance of patient imaging data from the obtained patient imaging data; and
for the identified instance of patient imaging data:
generating a set of feature characteristics for the feature type; and
inserting a computer-generated feature of the feature type into the instance of patient imaging data to generate an instance of synthetic patient imaging data.

5. The system of claim 4, wherein generating the synthetic training dataset further comprises:
annotating the instance of synthetic patient imaging according to a location associated with the computer-generated feature.

6. The system of claim 4, wherein generating the set of feature characteristics comprises at least one of:
determining a shape of the computer-generated feature;
determining a location of the computer-generated feature; or
determining a size of the computer-generated feature.

7. The system of claim 1, wherein processing the new patient imaging data according to the trained machine learning model comprises:
selecting the trained machine learning model from a set of machine learning models based on a set of characteristics associated with the new patient imaging data.

8. A method for processing patient imaging data according to a machine learning model trained using a synthetic training dataset, the method comprising:
providing, to a synthetic data platform, patient imaging data;
receiving, from the synthetic data platform, an indication of model processing result associated with the machine learning model; and
generating a display of at least a part of the patient imaging data in association with the model processing result.

9. The method of claim 8, wherein the patient imaging data is obtained from an image capture device prior to providing the patient imaging data to the synthetic data platform.

10. The method of claim 9, wherein:
the patient imaging data is provided to the synthetic data platform in association with an imaging device characteristic of the imaging device; and
the machine learning model is associated with the imaging device characteristic.

11. The method of claim 10, wherein the synthetic data platform trains the machine learning model in response to receiving the imaging device characteristic of the imaging device.

12. The method of claim 8, wherein the display comprises at least one of:
a region associated with a feature indicated by the model processing result; or
a confidence associated with the model processing result.

13. The method of claim 12, wherein the confidence is displayed in association with the region associated with the indicated feature.

14. A method for processing patient imaging data according to a machine learning model trained using a synthetic training dataset, the method comprising:
obtaining patient imaging data;
selecting a machine learning model from a set of machine learning models based on a set of characteristics associated with the patient imaging data;
processing the patient imaging data according to the selected machine learning model to generate a model processing result identifying a feature of the patient imaging data; and
providing an indication of the model processing result.

15. The method of claim 14, wherein the model is selected based on an imaging device characteristic of the set of characteristics.

16. The method of claim 14, wherein the model is selected based on an association between the machine learning model and a feature type of the identified feature.

17. The method of claim 14, wherein the patient imaging data is obtained from a patient imaging device and the indication of the model processing result is provided to a client device.

18. The method of claim 14, wherein selecting the machine learning model from the set of machine learning models comprises:
determining a machine learning model associated with a characteristic of the set of characteristics is not available in the set of machine learning models;
generating a synthetic training dataset associated with the characteristic;
training a machine learning model using the synthetic training dataset; and
using the trained machine learning model as the selected machine learning model.

19. The method of claim 14, wherein the model processing result includes at least one of:
a region associated with the identified feature; or
a confidence associated with the identified feature.

20. The method of claim 14, wherein:
the patient imaging data is a first instance of patient imaging data;
the set of characteristics is a first set of imaging device characteristics; and
the method further comprises:
receiving a second instance of patient imaging data associated with a second set of imaging device characteristics;
determining a machine learning model corresponding to the second set of imaging device characteristics is not available; and
based on determining the machine learning model is not available:
generating a synthetic training dataset for the second set of imaging device characteristics;
training a machine learning model using the synthetic training dataset; and
processing the second instance of patient imaging data according to the trained machine learning model to generate a model processing result.
